(19) United States
(12) Patent Application Publication
(10) Pub. No.: US 2013/0088480 A1
(43) Pub. Date: Apr. 11, 2013

(54) DRIVING METHOD FOR DISPLAY DEVICE

(71) Applicants: Won-Kee HONG, Anyang-si (KR); Jin-Ho PARK, Suwon-si (KR); Ick Kyu JANG, Seoul (KR); Jae Min HA, Yongin-si (KR)

(72) Inventors: Won-Kee HONG, Anyang-si (KR); Jin-Ho PARK, Suwon-si (KR); Ick Kyu JANG, Seoul (KR); Jae Min HA, Yongin-si (KR)

(73) Assignee: SAMSUNG DISPLAY CO., LTD., Yongin-City (KR)

(21) Appl. No.: 13/472,154

(22) Filed: May 15, 2012

(30) Foreign Application Priority Data
Oct. 5, 2011 (KR) 10-2011-0101139

(51) Int. Cl. G09G 5/00; G09G 3/36

(52) U.S. Cl. 345/212; 345/87

(57) ABSTRACT

A gate driver receiving a low voltage without an appropriate control signal in an initialization step from the time of turn-on of the power of the display device to the time of beginning of normal operation of the display device to previously generate and output a gate clock signal CPV so as to prevent a horizontal line defect from appearing. Thereby, the generated clock signals CKV and CKVB are transmitted to the gate driver such that the gate driver is appropriately controlled and the horizontal line defect is not generated.

### CROSS-REFERENCE TO RELATED APPLICATION

This application claims priority to and the benefit of Korean Patent Application No. 10-2011-0101139, filed on Oct. 5, 2011, which is hereby incorporated by reference for all purposes as if fully set forth herein.

### BACKGROUND

1. Field

Exemplary embodiments of the present invention relate to a driving method of a display device having an integrated gate driver.

2. Discussion of the Background

Among display panels, a liquid crystal display (LCD) is one type of a flat panel display that is currently being widely used, and includes two display panels in which field generating electrodes, such as a pixel electrode and a common electrode, etc., are formed, and a liquid crystal layer is disposed therebetween. The LCD displays images by applying voltages to the field-generating electrodes to generate an electric field in a liquid crystal (LC) layer that determines the orientations of LC molecules therein to adjust polarization of incident light. Other types of display panels include an organic light emitting device, a plasma display device, an electrophoretic display, etc., in addition to the liquid crystal display.

The display device including the LCD includes a gate driver and a data driver. Among them, the gate driver may be integrated in the panel while being patterned together with a gate line, a data line, a thin film transistor, etc. Since the integrated gate driver does not require an additional gate driving chip, it is possible to save manufacturing costs.

However, operational reliability of the integrated gate driver may suffer as a result of temperature changes. A characteristic of a semiconductor (particularly an amorphous semiconductor) of a thin film transistor in an integrated gate driver may change according to temperature, and as a result, a gate voltage output at a high temperature does not have a constant waveform and noise may be generated. Various proposals to reduce noise generated by the gate driver due to the high temperature have been proposed.

Also, the integrated gate driver may have a poor operation characteristic at a low temperature and a leakage current of some degree may be generated during the output of a gate-off signal such that a resulting power consumption may be high.

Meanwhile, the integrated gate driver may operate abnormally prior to the normal operation of the gate driver from a time that the power of the display device is turned on, which may contribute to the noise problem resulting from high temperature operation.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments of the present invention provide a method for driving a display device having an integrated gate driver in which abnormal operation is prevented prior to a normal operation of the gate driver from the time of turn-on of power for a display device.

Additional features of the invention will be set forth in the description which follows, and in part will be apparent from the description, or may be learned by practice of the invention.

An exemplary embodiment of the present invention discloses a driving method of a display device which includes: applying power to turn-on a display device including a display panel, an oscillator, and a signal controller; generating a gate clock signal by using the oscillator, the gate clock signal being output to the display panel; determining a characteristic of a display panel by the signal controller; and displaying an image to the display panel according to a control signal generated by the signal controller.

An exemplary embodiment of the present invention discloses a display device comprising an oscillator, a signal controller, a display panel comprising a display area comprising a gate line; and a gate driver connected to one end of the gate line, the gate driver comprising a plurality of stages, wherein each one of the plurality of stages receives a clock signal, a first low voltage and a second low voltage that is lower than the first low voltage, at least one transmitting signal output from among previous stages, and at least two transmitting signals among next stages to output a gate voltage having the first low voltage as a gate-off voltage, wherein a gate clock signal is generated by using the oscillator, the gate clock signal being output to the display panel, wherein the signal controller is configured to determine a characteristic of the display panel, and wherein the display panel displays an image according to a control signal generated by the signal controller.

An exemplary embodiment of the present invention discloses a display device comprising an oscillator, a signal controller, a display panel comprising a display area comprising a gate line; and a gate driver connected to one end of the gate line, the gate driver comprising a plurality of stages, wherein each one of the plurality of stages receives a clock signal, a low voltage, at least one transmitting signal among the previous stages, and at least two transmitting signals among the next stages to output a gate voltage having the first low voltage as a gate-off voltage, wherein a gate clock signal is generated by using the oscillator, the gate clock signal being output to the display panel, wherein the signal controller is configured to determine a characteristic of the display panel, and wherein the display panel displays an image according to a control signal generated by the signal controller.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a top plan view of a display device according to first exemplary embodiment of the present invention.

FIG. 1B is a block diagram of a signal controller according to the first exemplary embodiment of FIG. 1A.

FIG. 2 is a block diagram of a gate driver and a gate line of FIG. 1 in detail.

FIG. 3 is an enlarged circuit diagram of one stage and one gate line in FIG. 2.

FIG. 4 is a waveform diagram of a driving signal used in a display device according to the first exemplary embodiment of the present invention.

FIG. 5 is a flowchart of a driving method of a display device according to the first exemplary embodiment of the present invention.

FIG. 6 and FIG. 7 are views showing existence of deterioration generation of a display device according to a change of application timing of a driving signal according to the first exemplary embodiment of the present invention.

FIG. 8 is a view showing a display device in which a horizontal line error is generated.

FIG. 9 is a block diagram of a signal controller and an oscillator positioned outside the signal controller according to a second exemplary embodiment of the present invention.

FIG. 10 is a block diagram of a gate driver and a gate line of FIG. 1 according to a third exemplary embodiment in detail.

FIG. 11 is an enlarged circuit diagram of one stage and one gate line in FIG. 10.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure id thorough, and will fully convey the scope of the invention to those skilled in the art.

In the drawings, the thickness of layers, films, panels, regions, etc., are exaggerated for clarity. Like reference numerals denote like elements. It will be understood that when an element such as a layer, film, region, or substrate is referred to as being “on” or “connected to” another element, it can be directly on or directly connected to the other element or intervening elements may also be present. In contrast, when an element is referred to as being “directly on” or “directly connected to” another element, there are no intervening elements present. It will be understood that for purposes of this disclosure, “at least one of X, Y, and Z” can be construed as X only, Y only, Z only, or any combination of two or more items X, Y, and Z (e.g., XYZ, XYY, YZ, ZZ).

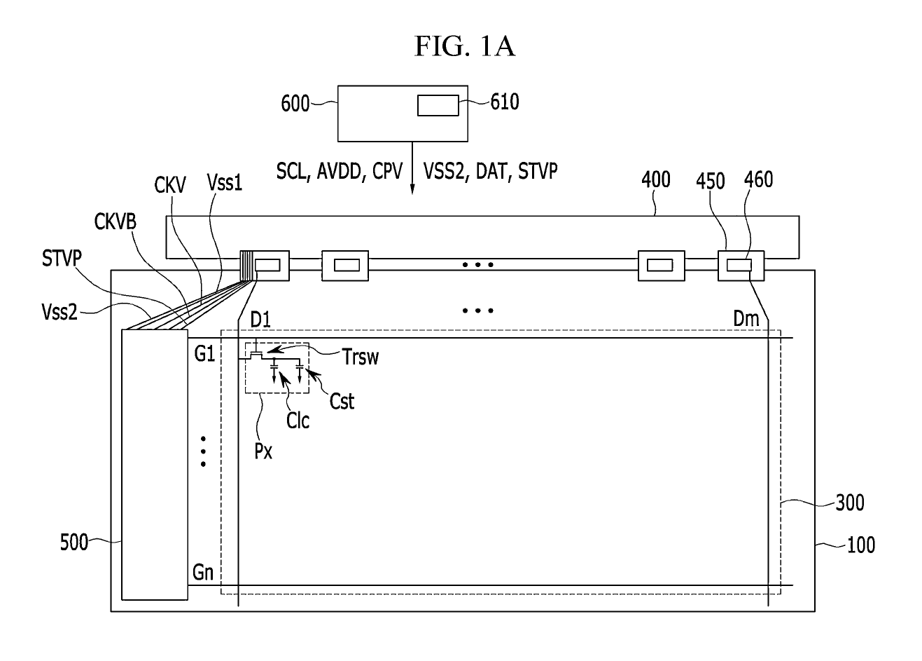

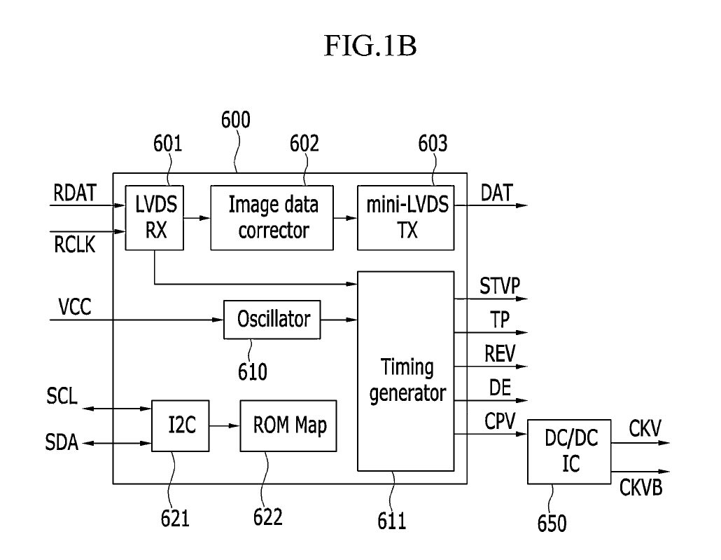

Now, a display device according to an exemplary embodiment of the present invention will be described with reference to FIG. 1A and FIG. 1B.

FIG. 1A is a top plan view of a display device according to a first exemplary embodiment of the present invention, and FIG. 1B is a block diagram of a signal controller according to the first exemplary embodiment of FIG. 1A.

Referring to FIG. 1A, a display device according to the first exemplary embodiment of the present invention includes a display panel 100, a data driver IC 460, and a signal controller 600 (referred to as T-con).

The display panel 100 includes a display area 300 displaying images and a gate driver 500 applying a gate voltage to a gate line of the display area 300. The data line of the display area 300 receives a data voltage from the data driver IC 460 formed on a flexible printed circuit film (FPC) 450 attached to the display panel 100. The gate driver 500 and the data driver IC 460 are controlled by the signal controller 600. A printed circuit board (PCB) is formed outside the flexible printed circuit film 450 such that a signal from the signal controller 600 is transmitted to the data driver IC 460 and the gate driver 500. According to the first exemplary embodiment, the signal controller 600 may be formed on the PCB.

The signal controller 600 includes an oscillator 610, and the signal provided from the signal controller includes a panel characteristic information signal SCL, a power voltage AVDD, a gate clock signal CPV, a low voltage Vss2, a scan start signal STVP, and image data DAT.

The panel characteristic information signal SCL refers to corresponding data as extended display identity data (EDID) of the display panel 100 transmitted through communication of an I2C standard for transmitting data through an SDA line and an SCL line (referring to an I2C transmitting/receiving unit 621 of FIG. 1B).

The power voltage AVDD is a basic voltage for various voltages used in the display device and is an analog voltage generated when power is applied to the display device.

A low voltage Vss2 is one voltage among two low voltages Vss1 and Vss2 used in the gate driver 500, and in a first exemplary embodiment of the present invention, the low voltage Vss1 generated based on the power voltage AVDD, and the low voltage Vss2 is additionally generated along with the power voltage AVDD.

The gate clock signal CPV is a signal that is a base of the first clock signal CKV and the second clock signal CKVB used in the gate driver 500 and may have the same cycle as the first clock signal CKV although voltage magnitudes thereof may differ. The second clock signal CKVB is generated by inverting the first clock signal CKV.

The scan start signal STVP is a control signal which starts the operation of the gate driver 500.

The image data DAT is digital data transmitted to the data driver IC 460 after image data input from the outside is appropriately processed.

A detailed structure of the signal controller 600 according to the first exemplary embodiment of the present invention will be described with reference to FIG. 1B.

The signal controller 600 includes an LVDS receiver (LVDS RX) 601, an image data corrector 602, a mini-LVDS transmitter (mini-LVDS TX) 603, an oscillator 610, a timing generator 611, an I2C transmitting/receiving unit 621, and a ROM Map 622.

The LVDS receiver 601 receives image data RDAT and an external clock signal RCLK of an LVDS type input from the outside, and converts it into RGB data to be processed in the signal controller 600 and then outputs the RGB data.

The image data corrector 602 processes the image data such that the RGB data received from the LVDS receiver 601 is appropriately displayed in the display panel 100. Processing of the image data may include execution of accurate color capture (ACC) for processing the data according to the gamma characteristic of the display device, and a dynamic capacitance compensation DCC process for compensating the data according to the difference between the image data of the current frame and the image data of the reference frame to improve the response speed of the liquid crystal display.

The mini-LVDS transmitter 603 converts the RGB data corrected in the image data corrector 602 through a mini-LVDS method and outputs it to the data driver IC 460.

In the above description, the image data between the outside and the signal controller 600 is received through the LVDS method, and the signal controller 600 and the data driver IC 460 transmit/receive the mini-LVDS, although they may be transmitted/received with various methods.

The external clock signal RCLK received from the LVDS receiver 601 is converted and transmitted to the timing generator 611, thereby generating various control signals (STVP, TP, REV, DE, CPV, etc).

As described above, the I2C transmitting/receiving unit 621 receives/transmits the extended display identity data (EDID) of the display panel 100 through the I2C standard for transmitting the data through the SDA line and the SCL line.

The ROM Map 622 connected to the I2C transmitting/receiving unit 621 stores the extended display identity data (EDID) of the display panel 100 and information for detailed tuning of the control signals (STVP, TP, REV, DE, and CPV) generated according to the characteristics of the display panel 100.

If the power supply voltage VCC is applied to the display device, the oscillator 610 directly receives the power supply voltage VCC such that the oscillator 610 is initially operated. The signal generated according to the operation of the oscillator 610 is transmitted to the timing generator 611 such that only the gate clock signal CPV is generated. The gate clock signal CPV generated in the timing generator 611 is transmitted to the DC/DC IC 650 such that the level thereof is converted, thereby generating the first clock signal CKV and the second clock signal CKVB. The first clock signal CKV and second clock signal CKVB are transmitted to the gate driver 500. As a result, the gate driver 500 is not abnormally operated by the applied clock signals CKV and CKVB during an initialization stage of the normal operation of the display device, which occurs at the turn-on of the power of the display device, such that deterioration of the horizontal line is not generated.

The oscillator 610 transmits the output to the timing generator 611 only in the initialization step, as described above, to generate the gate clock signal CPV. Meanwhile, according to the first exemplary embodiment, when the display device is normally operated, the operation may be executed, and in this case, a gray signal required to display the display device may be generated when the signal input from the outside is an abnormal signal.

The signal controller 600 generates the above-described signals, the voltage, and the image data to control the gate driver 500 and the data driver IC 460, thereby displaying the images.

In particular, if the signal controller 600 turns on the power such that the power voltage AVDD and the low voltage VSS2 are generated, the oscillator 610 is operated according to the I2C standard prior to the transmission of the panel characteristic information signal SCL to generate the gate clock signal CPV, thereby controlling the gate driver 500.

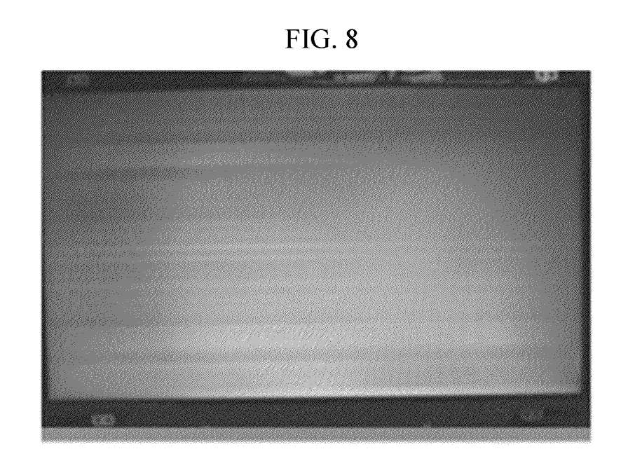

That is, the gate clock signal CPV acting as the base of the first clock signal CKV and the second clock signal CKVB applied to the gate driver 500 is generally generated when the display panel 100 is normally operated after receiving the panel characteristic information signal SCL such that the gate driver 500 may not be controlled when the gate driver 400 is abnormally operated until normal operation begins after the power is turned on. Particularly, the low voltage VSS2 is previously transmitted to the gate driver 500 and the different voltage (for example, the low voltage VSS1) is generated and applied according to the power voltage AVDD such that the horizontal line deterioration may be generated as shown in FIG. 8.

To eliminate this problem, in the first exemplary embodiment of the present invention, if the display device is turned on, the power voltage AVDD and the low voltage VSS2 are generated and the oscillator 610 of the signal controller 600 is operated to generate and output the gate clock signal CPV, and then the panel characteristic information signal SCL is received according to the I2C standard.

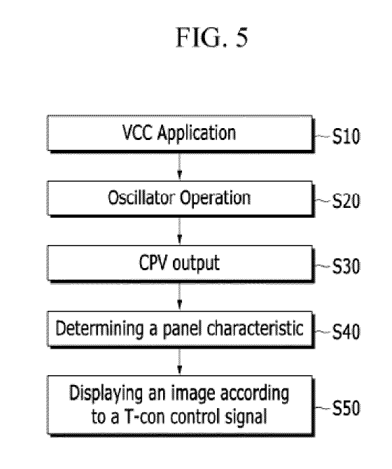

The period in which the gate driver 500 is abnormally operated is eliminated through this process such that the display quality is improved. This will be described with reference to FIG. 5 later.

In the case of the liquid crystal panel, the display area 300 includes a thin film transistor Trsw, a liquid crystal capacitor Clc, and a storage capacitor Cst, and FIG. 1A shows an example of the liquid crystal panel. Meanwhile, an organic light emitting panel includes a thin film transistor and an organic light emitting diode, and another display panel includes an element such as a thin film transistor to form the display area 300. Hereafter, an example of the liquid crystal panel is described.

The display area 300 includes a plurality of gate lines G1-Gn and a plurality of data lines D1-Dm, and the plurality of gate lines G1-Gn and the plurality of data lines D1-Dm are insulated from and intersect each other.

Each pixel PX includes the thin film transistor Trsw, the liquid crystal capacitor Clc, and the storage capacitor Cst. A control terminal of the thin film transistor Trsw is connected to one gate line, an input terminal of the thin film transistor Trsw is connected to one data line, and an output terminal of the thin film transistor Trsw is connected to one terminal of the liquid crystal capacitor Clc and one terminal of the storage capacitor Cst. The other terminal of the liquid crystal capacitor Clc is connected to a common electrode, and a storage voltage output from the signal controller 600 is applied to the other terminal of the storage capacitor Cst.

The plurality of data lines D1-Dm receives the data voltage from the data driver IC 460, and the plurality of gate lines G1-Gn receives the gate voltage from the gate driver 400.

The data driver 500 is connected to the data lines D1-Dm formed at an upper or lower side of the display panel 100 and extended in a longitudinal direction, and in the first exemplary embodiment shown in FIG. 1A, the data driver IC 460 is positioned at the upper side of the display panel 100.

The gate driver 500 receives the clock signals CKV and CKVB, the scan start signal STVP, the first low voltage Vss1 corresponding to the gate-off voltage, and the second low voltage Vss2 that is lower than the gate-off voltage to generate the gate voltage (the gate-on voltage and the gate-off voltage), and sequentially applies the gate-on voltage to the gate lines G1-Gn.

The clock signals CKV and CKVB are generated based on the gate clock signal CPV of the signal controller 600, and according to the first exemplary embodiment, the clock signals CKV and CKVB that are generated based on the gate clock signal CPV may be transmitted to the gate driver 500 in the signal controller 600. The gate clock signal CPV and the first clock signal CKV have the same cycle, however, the voltage magnitudes thereof are different and the second clock signal CKVB is inverted with respect to the first clock signal CKV.

The first low voltage Vss1 according to a first exemplary embodiment of the present invention is generated based on the power voltage AVDD, and the second low voltage Vss2 is generated according to the turn-on of the power of the display device along with the power voltage AVDD.

The clock signals CKV and CKVB, the scan start signal STVP, the first low voltage Vss1, and the second low voltage Vss2 applied to the gate driver 500 are applied to the gate driver 500 via the flexible printed circuit film 450 that is positioned at the outermost side and at the side of the gate driver 500, as shown in FIG. 1A. These signals are transmitted from the outside or the signal controller 600 to the flexible printed circuit film 450 via the PCB 400.

The entire structure of the display device is fully described above.

Next, the gate driver 500 and the gate lines G1-Gn will be described.

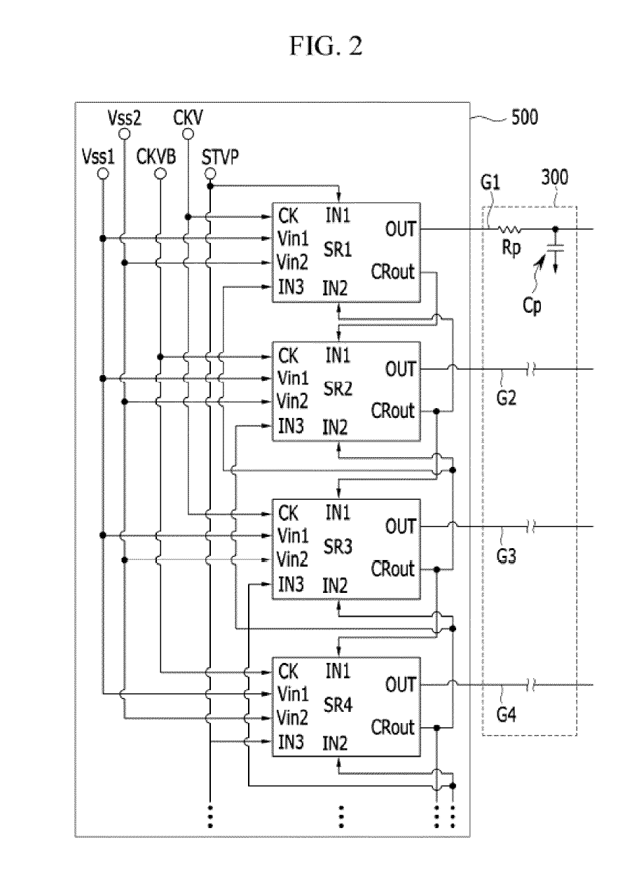

FIG. 2 is a block diagram of the gate driver and the gate lines of FIG. 1A.

FIG. 2 shows the gate driver 500 in block form in detail.

In FIG. 2, the display area 300 is shown as a resistor Rp and a capacitor Cp. The gate lines G1-Gn, the liquid crystal capacitor Clc, and the storage capacitor Cst respectively have resistances and capacitances, and the sums thereof are respectively represented as one resistance Rp and one capacitance Cp. The gate voltages respectively output from the stages SR1, SR2, SR3, SR4 . . . are transmitted through the gate lines. As shown in FIG. 2, each gate line may be represented as a resistor Rp and a capacitor Cp in a circuit diagram. These values are whole values for one gate line, and may be changed according to the structure and the characteristics of the display area 300.

Next, the gate driver 500 will be described.

The gate driver 500 includes a plurality of stages SR1, SR2, SR3, SR4 . . . that are dependently connected to each other. Each of the stages SR1, SR2, SR3, SR4 . . . includes three input terminals IN1, IN2, and IN3, one clock input terminal CK, two voltage input terminals Vin1 and Vin2, a gate voltage output terminal OUT outputting the gate voltage, and a transmission signal output terminal CRout.

The first input terminal IN1 is connected to the transmission signal output terminal CRout of the previous stage, thereby receiving the transmission signal CR of the previous stage, and the first stage does not have a previous stage such that the scan start signal STVP is applied to the first input terminal IN1.

The second input terminal IN2 is connected to the transmission signal output terminal CRout of the next stage, thereby receiving the transmission signal CR of the next stage. Also, the third input terminal IN3 is connected to the transmission signal output terminal CRout of the second next stage, thereby receiving the transmission signal CR of the second next stage.

A stage SRn (not shown) connected to the n-th gate line Gn may have two dummy stages to receive the transmission signal CR from the next stage and the second next stage. The dummy stages SR(n+1) and SR(n+2) (not shown) are stages that generate and output a dummy gate voltage, in contrast to the different stages SR1-SRn. That is, the gate voltage output from the stages SR1-SRn is transmitted via the gate lines such that the data voltage is applied to the pixels for the display of the images. However, the dummy stages SRn+1 and SRn+2 may not be connected to the gate lines, although when they are connected to the gate lines they are connected to the gate lines of dummy pixels (not shown) that do not display the image such that they may not be used for the display of the image.

A clock signal is applied to the clock terminals CK, and among the plurality of stages, the first clock signal CKV is applied to the clock terminals CK of the odd-numbered stages and the second clock signal CKVB is applied to the clock terminals CK of the even-numbered stages. The first clock signal CKV and the second clock signal CKVB have different phases.

The first low voltage Vss1 corresponding to the gate-off voltage is applied to the first voltage input terminal Vin1, and the second low voltage Vss2 that is lower than the first low voltage Vss1 is applied to the second voltage input terminal Vin2. The voltage values of the first low voltage Vss1 and the second low voltage Vss2 may vary according to the exemplary embodiment, and in the first exemplary embodiment, the first low voltage Vss1 may be −5V and the second low voltage Vss2 may be −10V.

The operation of the gate driver 500 will now be described.

The first stage SR1 receives the first clock signal CKV provided from the outside via the clock input terminal CK, the scan start signal STVP via the first input terminal IN1, the first and second low voltages Vss1 and Vss2 via the first and second voltage input terminals Vin1 and Vin2, respectively, and the transmission signals CR respectively provided from the second stage SR2 and the third stage SR3 via the second and third input terminals IN2 and IN3 such that the gate-on voltage is output to the first gate line via the gate voltage output terminal OUT. Also, the transmission signal output terminal CRout outputs the transmission signal CR, and it is transmitted to the first input terminal IN1 of the second stage SR2.

The second stage SR2 receives the second clock signal CKVB provided from the outside via the clock input terminal CK; the transmission signal CR of the first stage SR1 via the first input terminal IN1; the first and second low voltages Vss1 and Vss2 via the first and second voltage input terminals Vin1 and Vin2, respectively; and the transmission signals CR respectively provided from the third stage SR3 and the fourth stage SR4 via the second and third input terminals IN2 and IN3 such that the gate-on voltage is output to the second gate line via the gate voltage output terminal OUT. The transmission signal CR is output via the transmission signal output terminal CRout, thereby being transmitted to the first input terminal IN1 of the third stage SR3 and the second input terminal IN2 of the first stage SR1.

The third stage SR3 receives the first clock signal CKV provided from the outside via the clock input terminal CK; the transmission signal CR of the second stage SR2 via the first input terminal IN1; the first and second low voltages Vss1 and Vss2 via the first and second voltage input terminals Vin1 and Vin2; and the transmission signals CR respectively provided from the fourth stage SR4 and the fifth stage SR5 via the second and third input terminals IN2 and IN3 such that the gate-on voltage is output to the third gate line via the gate voltage output terminal OUT. The transmission signal CR is output via the transmission signal output terminal CRout thereby being transmitted to the first input terminal IN1 of the fourth stage SR4, the third input terminal IN3 of the first stage SR1, and the second input terminal IN2 of the second stage SR2.

Through the above method, the n-th stage SRn receives the second clock signal CKVB provided from the outside via the clock input terminal CK; the transmission signal CR of the (n−1)-th stage SR2 via the first input terminal IN1; the first and second low voltages Vss1 and Vss2 via the first and second voltage input terminals Vin1 and Vin2, respectively; and the transmission signals CR respectively provided from the (n+1)-th stage SR(n+1) (the dummy stage) and the (n+2)-th stage SR(n+2) (the dummy stage) via the second and third input terminals IN2 and IN3 such that the gate-on voltage is output to the n-th gate line through the gate voltage output terminal OUT. The transmission signal CR is output via the transmission signal output terminal CRout, thereby being transmitted to the first input terminal IN1 of the (n+1)-th stage SR(n+1) (the dummy stage), the third input terminal IN3 of the (n−2)-th stage SR(n−2), and the second input terminal IN2 of the (n−1)-th stage SR(n−1).

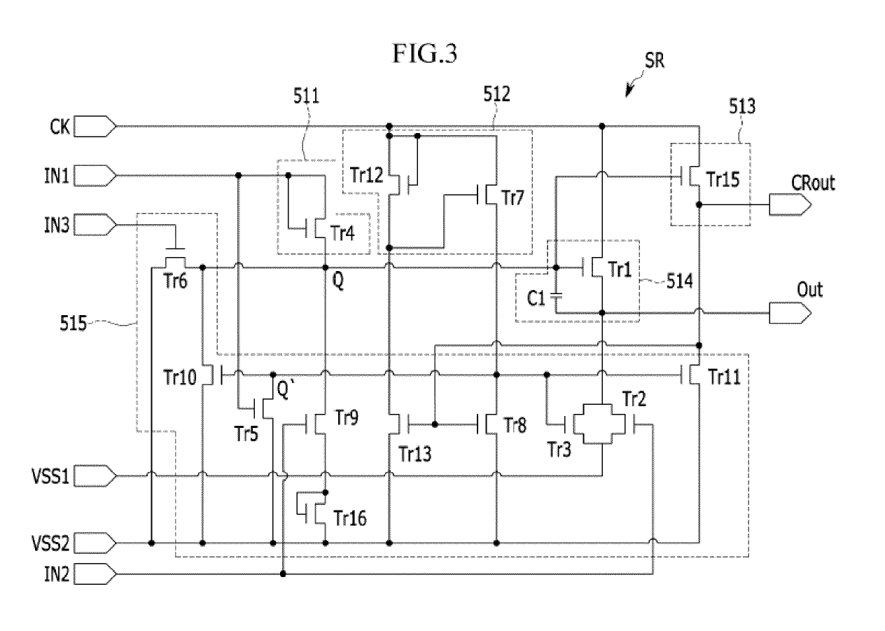

The connection structure of the stages SR of the entire gate driver 500 has been described with reference to FIG. 2. Next, a structure of a stage SR of a gate driver connected to one gate line will be described in further detail with reference to FIG. 3.

FIG. 3 is an enlarged circuit diagram of one stage SR connected to one gate line in FIG. 2.

Referring to FIG. 3, each stage SR of the gate driver 500 according to the first exemplary embodiment includes an input section 511, a pull-up driver 512, a transmission signal generator 513, an output section 514, and a pull-down driver 515.

The input section 511 includes one transistor (the fourth transistor Tr4), where the input terminal and the control terminal of the fourth transistor Tr4 are commonly connected (diode-connected) to the first input terminal IN1, and the output terminal thereof is connected to a node Q (hereinafter referred to as the first node). The input section 511 has a function of transmitting high voltage to the node Q when the first input terminal IN1 is applied with high voltage.

The pull-up driver 512 includes two transistors (the seventh transistor Tr7 and the twelfth transistor Tr12). The control terminal and the input terminal of the twelfth transistor Tr12 are diode-connected, thereby receiving the first clock signal CKV or the second clock signal CKVB via the clock terminal CK, and the output terminal is connected to the control terminal of the seventh transistor Tr7 and the pull-down driver 515. The input terminal of the seventh transistor Tr7 is also connected to the clock terminal CK, and the output terminal is connected to the node Q′ (hereinafter referred to as the “second node”) and is passed via the node Q′, thereby being connected to the pull-down driver 515. The control terminal of the seventh transistor Tr7 is connected to the output terminal of the twelfth transistor Tr12 and the pull-down driver 515. Here, a parasitic capacitance (not shown) may be respectively formed between the input terminal and the control terminal, and the control terminal and the output terminal, of the seventh transistor Tr7. If the high signal is applied to the pull-up driver 512 at the clock terminal CK, the high signal is transmitted to the control terminal of the seventh transistor Tr7 and the pull-down driver 515 through the twelfth transistor Tr12. The high signal transmitted to the seventh transistor Tr7 turns on the seventh transistor Tr7, and, as a result, the high signal applied from the clock terminal CK is applied to the node Q′.

The transmission signal generator 513 includes one transistor (the fifteenth transistor Tr15). The input terminal of the fifteenth transistor Tr15 is connected to the clock terminal CK, thereby receiving the first clock signal CKV or the second clock signal CKVB. The control terminal thereof is connected to the output terminal of the input section 511, that is, the node Q, and the output terminal thereof is connected to the transmission signal output terminal CRout outputting the transmission signal CR. Here, a parasitic capacitance (not shown) may be formed between the control terminal and the output terminal. The output terminal of the fifteenth transistor Tr15 is connected to the pull-down driver 515 as well as the transmission signal output terminal CRout, thereby receiving the second low voltage Vss2. As a result, the voltage value when the transmission signal CR is low is the second low voltage Vss2.

The output section 514 includes one transistor (the first transistor Tr1) and one capacitor (the first capacitor C1). The control terminal of the first transistor Tr1 is connected to the node Q, and the input terminal thereof receives the first clock signal CKV or the second clock signal CKVB via the clock terminal CK. The first capacitor C1 is formed between the control terminal and the output terminal, and the output terminal thereof is connected to the gate voltage output terminal OUT. The output terminal is connected to the pull-down driver 515, thereby receiving the first low voltage Vss1. As a result, the value of the voltage of the gate-off voltage is the first low voltage Vss1. This output section 514 outputs the gate voltage according to the voltage of the node Q and the first clock signal CKV.

The pull-down driver 515 removes charges remaining at the stage SR to smoothly output the gate-off voltage and the low voltage of the transmission signal CR, thereby decreasing the potential of the node Q, the potential of the node Q′, the voltage output to the transmission signal CR, and the voltage output to the gate line. The pull-down driver 515 include ten transistors (the second transistor Tr2, the third transistor Tr3, the fifth transistor Try, the sixth transistor Tr6, the eighth transistor Tr8 to the eleventh transistor Tr11, the thirteenth transistor Tr13, and the sixteenth transistor Tr16).

The transistors pulling down the node Q will now be described. The transistors pulling down the node Q are the sixth transistor Tr6, the ninth transistor Tr9, the tenth transistor Tr10, and the sixteenth transistor Tr16.

The control terminal of the sixth transistor Tr6 is connected to the third input terminal IN3, the output terminal thereof is connected to the second voltage input terminal Vin2, and the input terminal thereof is connected to the node Q. Therefore, the sixth transistor Tr6 is turned on according to the transmission signal CR applied from the second next stage, thereby decreasing the voltage of the node Q to the second low voltage Vss2.

The ninth transistor Tr9 and the sixteenth transistor Tr16 are operated together, thereby pulling down the node Q. The control terminal of the ninth transistor Tr9 is connected to the second input terminal IN2, the input terminal thereof is connected to the node Q, and the output terminal thereof is connected to the input terminal and the control terminal of the sixteenth transistor Tr16. The control terminal and the input terminal of the sixteenth transistor Tr16 are diode-connected to the output terminal of the ninth transistor Tr9, and the output terminal thereof is connected to the second voltage input terminal Vin2. Therefore, the ninth is transistor Tr9 and the sixteenth transistor Tr16 are turned on according to the transmission signal CR applied from the next stage, and thereby functions to decrease the voltage of the node Q to the second low voltage Vss2.

The input terminal of the tenth transistor Tr10 is connected to the node Q, the output terminal thereof is connected to the second voltage input terminal Vin2, and the control terminal thereof is connected to the node Q′ (which has voltage opposite that of the node Q such that it is referred to as a reverse terminal). Therefore, the tenth transistor Tr10 functions to continuously decrease the voltage of the node Q to the second low voltage Vss2 in the general period when the node Q′ has the high voltage, and then prevents lowering of the voltage of the node Q when the voltage of the node Q′ has the low voltage. When the voltage of the node Q is not decreased, the corresponding stage outputs the gate-on voltage and the transmission signal CR.

The transistors which pull down the node Q′ in the pull-down driver 515 will now be described. The transistors which pull down the node Q′ are the fifth transistor Tr5, the eighth transistor Tr8, and the thirteenth transistor Tr13.

The control terminal of the fifth transistor Tr5 is connected to the first input terminal IN1, the input terminal thereof is connected to the node Q′, and the output terminal thereof is connected to the second voltage input terminal Vin2. As a result, the fifth transistor Tr5 decreases the voltage of the node Q′ to the second low voltage Vss2 according to the transmission signal CR of the previous stage.

On the other hand, the control terminal of the eighth transistor Tr8 is connected to the transmission signal output terminal CRout of the corresponding stage; the input terminal is connected to the node Q′; and the output terminal is connected to the second voltage input terminal Vin2. As a result, the eighth transistor Tr8 functions to decrease the voltage of the node Q′ to the first low voltage Vss1 according to the transmission signal CR of the corresponding stage.

The control terminal of the thirteenth transistor Tr13 is connected to the transmission signal output terminal CRout of the corresponding stage; the input terminal is connected to the output terminal of the twelfth transistor Tr12 of the pull-up driver 512; and the output terminal is connected to the first voltage input terminal Vin1. As a result, the thirteenth transistor Tr13 functions to decrease the inner potential of the pull-up driver 512 to the first low voltage Vss1 and decrease the voltage of the node Q′ connected to the pull-up driver 512 to the first low voltage Vss1 according to the transmission signal CR of the corresponding stage. That is, the thirteenth transistor Tr13 functions to discharge the inner charges of the pull-up driver 512 to the first low voltage Vss1. However, the pull-up driver 512 is also connected to the node Q′ to prevent pull-up of the voltage of the node Q′ such that the thirteenth transistor Tr13 assists to decrease the voltage of the node Q′ to the second low voltage Vss2.

The eleventh transistor Tr11 which decreases the voltage output to the transmission signal CR in the pull-down driver 515 will now be described.

The control terminal of the eleventh transistor Tr11 is connected to the node Q′; the input terminal is connected to the transmission signal output terminal CRout, and the output terminal is connected to the second voltage input terminal Vin2. As a result, when the voltage of the node Q′ is high, the voltage of the transmission signal output terminal CRout is decreased to the second low voltage Vss2 such that the transmission signal CR is changed to the low level.

The second transistor Tr2 and the third transistor Tr3, which decrease the voltage output to the gate line from the pull-down driver 515, will now be described. The control terminal of the second transistor Tr2 is connected to the second input terminal IN2; the input terminal is connected to the gate voltage output terminal OUT; and the output terminal is connected to the first voltage input terminal Vin1. As a result, when the transmission signal CR of the next stage is output, the gate voltage output is changed to the first low voltage Vss1.

The control terminal of the third transistor Tr3 is connected to the node Q′; the input terminal is connected to the gate voltage output terminal OUT; and the output terminal is connected to the first voltage input terminal Vin1. As a result, the gate voltage output when the voltage of the node Q′ is high is changed to the first low voltage Vss1.

In the pull-down driver 515, the gate voltage output terminal OUT is decreased to the first low voltage Vss1, and the node Q and the transmission signal output terminal CRout are decreased to the second low voltage Vss2 that is lower than the first low voltage Vss1. As a result, although the gate-on voltage and the high voltage of the transmission signal CR may be the same, the gate-off voltage and the low voltage of the transmission signal CR are different. That is, the gate-off voltage is the first low voltage Vss1, and the low voltage of the transmission signal CR is the second low voltage Vss2.

The gate voltage and transmission signal CR may have various voltage values. However, in the first exemplary embodiment, the gate-on voltage may be 25V, the gate-off voltage and the first low voltage Vss1 may be −5V, the high voltage of the transmission signal CR may be 25V, and the low voltage and the second low voltage Vss2 may be −10V.

In summary, the transmission signal generator 513 and the output unit 514 are operated by the voltage of the node Q such that one stage SR outputs the high voltage of the transmission signal CR and the gate-on voltage; the transmission signal CR is decreased from the high voltage to the second low voltage Vss2 by the previous, the next, and the second next transmission signals CR; and the gate-on voltage is decreased to the first low voltage Vss1, thereby representing the gate-off voltage. Here, one stage SR decreases the voltage of the node Q to the second low voltage Vss2 by the second next transmission signal CR as well as the next transmission signal CR to reduce power consumption, and the second low voltage Vss2 is lower than the first low voltage Vss1 (the gate-off voltage) whereby the second low voltage Vss2 is sufficiently low such that the transistors included in the stage prevent flow of the leakage current, and thereby power consumption may be decreased even though the transmission signal CR applied in the different stage includes ripple or other noise, such that the voltage is changed.

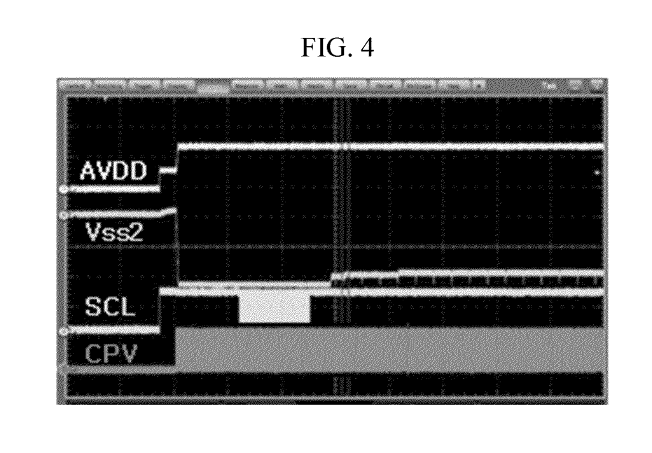

Next, the driving method of the display device preventing an abnormal operation of the gate driver 500 shown in FIG. 2 and FIG. 3 will be described with reference to FIG. 4 and FIG. 5.

FIG. 4 is a waveform diagram of a driving signal used in a display device according to a first exemplary embodiment of the present invention, and FIG. 5 is a flowchart showing a driving method of a display device according to a first exemplary embodiment of the present invention.

If the display device is applied with the power supply voltage VCC (S10), the power voltage ADVV and the low voltage Vss2 are generated in the display device such that a basic voltage generating other voltages required for the display device is generated. In FIG. 4, if the power supply voltage VCC is applied, the power voltage AVDD is increased through two steps and reaches the final power voltage AVDD, and thereby it may be confirmed that the low voltage Vss2 is decreased to the low voltage corresponding to the second increase of the power voltage AVDD.

Next, the operation of the oscillator 610 included in the signal controller 600 of the display device is started (S20) such that the gate clock signal CPV is generated and output to the gate driver 500. FIG. 4 shows that the gate clock signal CPV is generated (S30). The clock signals CKV and CKVB used in the gate driver 500 are generated by the gate clock signal CPV for the gate driver 500 to be controlled. Here, the gate clock signal CPV and the first clock signal CKV have the same cycle. However, the voltage magnitudes thereof are different, and the second clock signal CKVB has an inverse relation with respect to the first clock signal CKV.

Next, the signal controller 600 receives the panel characteristic information signal SCL from the display panel 100 according to the I2C standard and determines the characteristic of the display panel 100 (S40) that is used when displaying the image. In FIG. 4, it may be confirmed that, if the display panel 100 and the signal controller 600 exchange the data according to the I2C standard during a predetermined period, the panel characteristic information signal SCL is generated during the predetermined period and then disappears, and then all data is transmitted to the signal controller 600, and the transmission of the data is finished.

If preparation of the normal operation of the display device is finished through these processes, the signal controller 600 outputs all control signals and the image data DAT to display the images (S50).

As a result, in the initialization step from the turn-on of the power supply voltage VCC of the display device to the normal operation of the display device, the gate driver 500 receives the voltage Vss2 (the low voltage) to generate and output the gate clock signal CPV without the appropriate control signal such that the horizontal line deterioration does not appear (referring to FIG. 8), and thereby the clock signals CKV and CKVB are generated to control the gate driver 500 without the horizontal line deterioration.

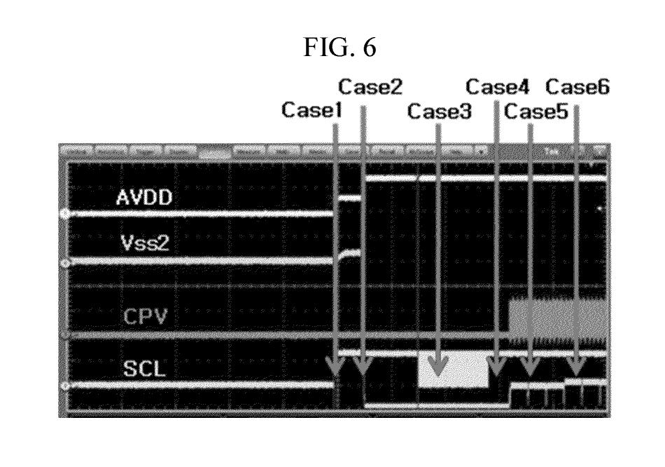

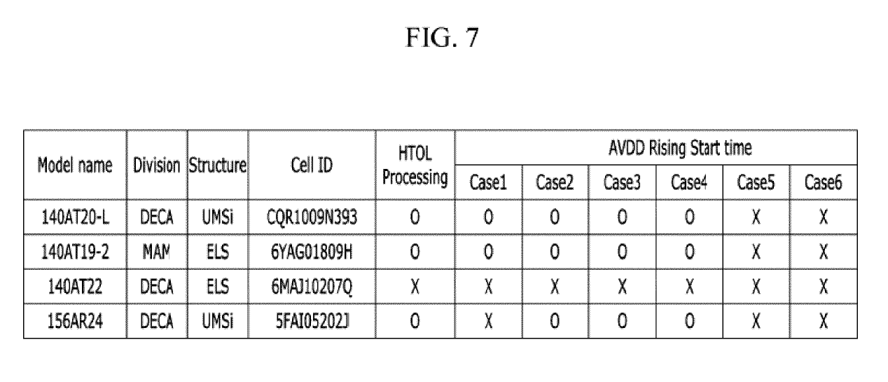

Next, an experimental result of generation of the horizontal line deterioration according to timing of the application of the power voltage AVDD will be described with reference to FIG. 6 and FIG. 7.

FIG. 6 and FIG. 7 are views showing the existence of deterioration generation of a display device according to a change of application timing of a driving signal according to the first exemplary embodiment of the present invention.

The first exemplary embodiment shown in FIG. 6 and FIG. 7 confirms whether a defect is generated in the gate driver 500 according to a time that the power voltage AVDD is applied in the display device.

Referring to FIG. 6, the power voltage AVDD is applied as in FIG. 4. However, this is only one among six cases (case 1), and the case of applying the power voltage AVDD is divided into five in FIG. 6.

In case 1, a power supply voltage Vcc is begun to be applied and simultaneously the power voltage AVDD is directly applied. This case in which no different control voltage transmitted to the gate driver 500 exists.

In case 2, the low voltage Vss2 is applied as the low voltage and simultaneously the power voltage AVDD is applied. In this case, there is no different control voltage transmitted to the gate driver 500.

In case 3, the power voltage AVDD is applied while the display panel 100 and the signal controller 600 exchange the panel characteristic information signal SCL by using the I2C standard.

In case 4, the power voltage AVDD is applied at a time that the gate clock signal CPV is begun to be applied and a control signal like STH is applied.

In cases 5 and 6, the power voltage AVDD is applied when the normal display operation of the display panel is possible through the initialization process.

Referring to FIG. 7, it is confirmed whether the defect is generated with reference to a total of four example embodiments for the six cases in FIG. 6.

The first example embodiment 140AT20-L uses the gate driver 500 of FIG. 2 and FIG. 3 (indicated by DECA), and is performed for a panel executed with a high temperature reliability test HTOL.

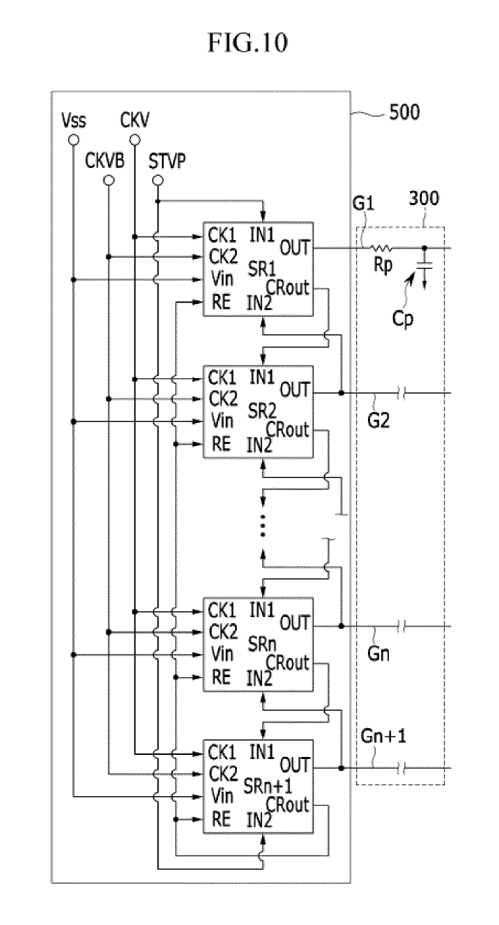

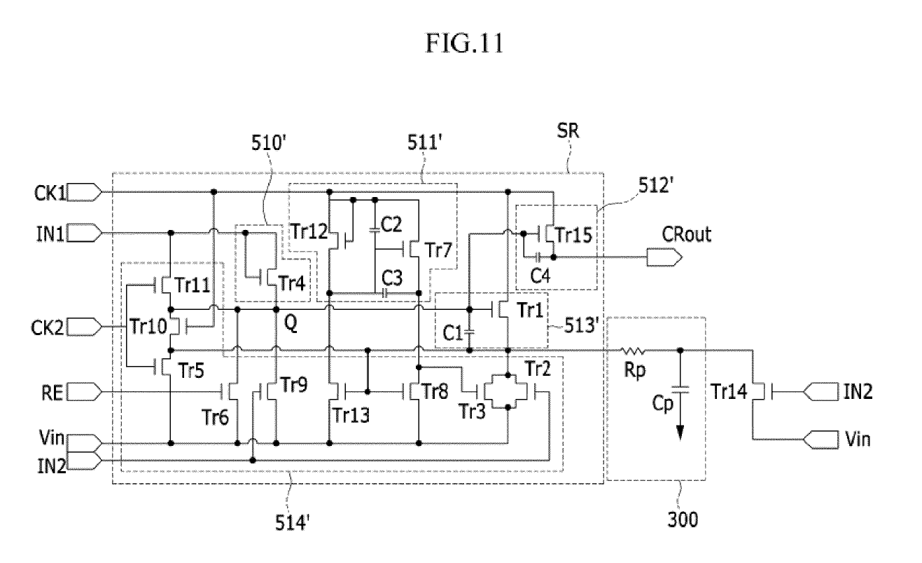

The second example embodiment 140AT19-2 (indicated by MAM) uses a gate driver 500 of FIG. 10 and FIG. 11 that will be described later and is performed for the panel executed with a high temperature reliability test HTOL.

The third example embodiment 140AT22 uses the gate driver 500 of FIG. 2 and FIG. 3, and is performed for the panel that is not executed with a high temperature reliability test HTOL.

The fourth example embodiment uses the gate driver 500 of FIG. 10 and FIG. 11, and is performed for the panel executed with a high temperature reliability test HTOL.

In FIG. 7, o indicates a case that the defect is generated, and x indicates a case that the defect is not generated.

The defect is not generated in any case for the third example embodiment 140AT22. This is because the third example embodiment (140AT22) is not a good display device, and does not undergo the high temperature reliability test (HTOL) such that the characteristic of the amorphous semiconductor forming the channel of the transistor included in the gate driver 500 is not changed and, therefore the defect is not generated, and the third example embodiment (140AT22) has a possibility that the defect may be generated after usage for long time.

Meanwhile, it may be confirmed that the defect is not generated in only case 5 and case 6 for the example embodiment that undergoes the high temperature reliability test HTOL.

It is determined that the voltage (generated based on the power voltage AVDD) and the clock signal (generated based on the gate clock signal CPV) applied to the gate driver 500 are applied together so that the gate driver 500 is not abnormally operated, and thereby the case 5 and the case 6 are not generated.

Therefore, like the first exemplary embodiment of the present invention, if the gate clock signal CPV is generated directly by the oscillator 610 after the power voltage AVDD is applied, the abnormality of the gate driver 500 is prevented and, as a result, as shown in FIG. 8, the horizontal line defect is not generated. Particularly, as shown in FIG. 7, although the characteristic of the amorphous semiconductor of the gate driver 500 is changed through the high temperature reliability test (HTOL), the defect is not generated such that the display quality is not deteriorated although the display device is used for a long time.

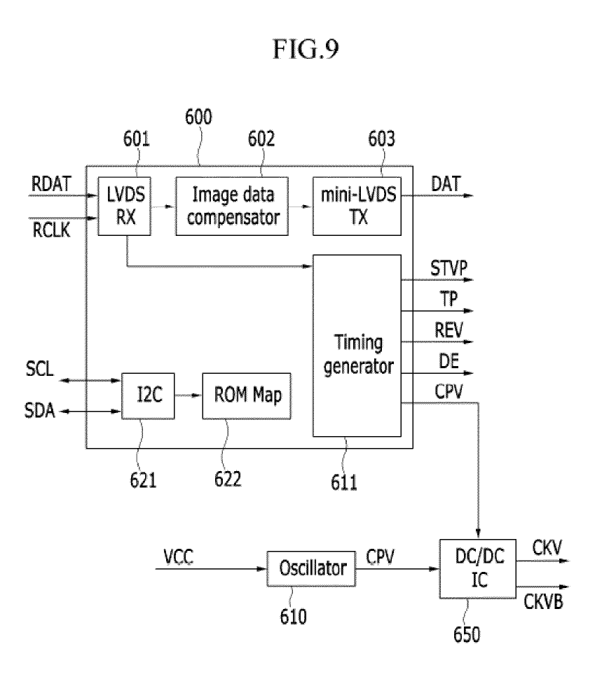

FIG. 9 shows a structure of a signal controller according to a second exemplary embodiment which is different from the first exemplary embodiment shown in FIG. 1B.

FIG. 9 is a block diagram of a signal controller and an oscillator positioned outside the signal controller according to the second exemplary embodiment of the present invention.

The same description for FIG. 9 and FIG. 1B is omitted.

In the second exemplary embodiment of FIG. 9, the oscillator 610 exists outside the signal controller 600, in contrast to the arrangement of the first exemplary embodiment of FIG. 1B. As a result, the oscillator 610 directly receives the power supply voltage VCC if the display device is applied with the power supply voltage VCC and the oscillator 610 is operated separately from the signal controller 600. The gate clock signal CPV is generated according to the operation of the oscillator 610, and the generated gate clock signal CPV is transmitted to the DC/DC IC 650 and the level thereof is converted, and thereby the first clock signal CKV and the second clock signal CKVB are generated. The generated first clock signal CKV and second clock signal CKVB are transmitted to the gate driver 500.

In the second exemplary embodiment of FIG. 9, the oscillator 610 is also initially operated before the signal controller 600 is normally operated. As a result, the gate driver 500 is not abnormally operated by the applied clock signals CKV and CKVB in the initialization step from the turn-on of the power of the display device to the normal operation of the display device such that the horizontal line defect is not generated.

The oscillator 610 according to the second exemplary embodiment of FIG. 9 may be operated only in the initialization step.

In the second exemplary embodiment of FIG. 9, the timing generator 611 generates the control signals (STVP, TP, REV, DE, CPV, etc.) according to only the output signal of the LVDS receiver 601, in contrast to the first exemplary embodiment of FIG. 1B. That is, the external clock signal RCLK received by the LVDS receiver 601 is converted and transmitted to the timing generator 611, thereby representing the basic signal through which the various control signals (STVP, TP, REV, DE, CPV, etc.) are generated.

Next, a gate driver 500 according to the second exemplary embodiment of the present invention will be described with reference to FIG. 10 and FIG. 11.

FIG. 10 is a block diagram of a gate driver and a gate line of FIG. 1 according to the second exemplary embodiment in detail, and FIG. 11 is an enlarged circuit diagram of one stage and one gate line in FIG. 10.

FIG. 10 shows the gate driver 500 in detail.

First, the gate driver 500 includes a plurality of stages SR1-SR(n+1) that are connected to each other in a cascade form. Each stage SR1-SR(n+1) includes two input terminals IN1 and IN2, two clock input terminals CK1 and CK2, a voltage input terminal Vin having applied to it a low voltage Vss approximating the gate-off voltage, a reset terminal RE, an output terminal OUT, and a transmission signal output terminal CRout.

First, the first input terminal IN1 is connected to the transmission signal output terminal CRout of a previous stage to receive the transmission signal CR of the previous stage. The first stage receives the scan starting signal STVP from a first input terminal IN1 since there is no previous stage.

The second input terminal IN2 is connected to the output terminal OUT of the next stage to receive the gate voltage of the next stage. Herein, in the case of an (n+1)-th stage SR(n+1) (dummy stage) that is formed last, the scan starting signal STVP is applied to a second input terminal IN2 since there is no next stage.

The first clock CKV is applied to the first clock terminals CK1 of odd-numbered stages of the plurality of stages and the second clock CKVB having an inverted phase is applied to the second clock terminal CK2. Meanwhile, the second clock CKVB is applied to the first clock terminal CK1 of even-numbered stages and the first clock CKV is applied to the second clock terminal CK2 thereof, such that the phase of the clock signals input to the same terminal are opposite each other, as compared with the odd-numbered stage.

The low voltage Vss approximating the gate-off voltage is applied to the voltage input terminal Vin, and the reset terminal (RE) is connected to the transmission signal output terminal CRout of the dummy stage SR(n+1) that is positioned last.

Herein, the dummy stage SR(n+1) is a stage that generates and outputs the dummy gate voltage, unlike the other stages SR1-SRn. In other words, the gate voltages output from other stages SR1-SRn are transferred through the gate line and the data voltage is applied to the pixel to display the images, but the dummy stage SR(n+1) may not be connected to the gate line and, even if it is connected to the gate line, it may be connected to a gate line of a dummy pixel (not shown) that does not display the image, such that it is not used to display images (referring to FIG. 10).

The operation of the main gate driver 500 will be described below.

First, the first and second clock signals CKV and CKVB are applied to the first stage SR1 via the first clock input terminal CK1 and the second clock input terminal CK2, respectively, from the outside and the scan starting signal STVP is input via the first input terminal IN1; the low voltage Vss approximating the gate-off voltage is applied to the voltage input terminal Vin, and the gate voltage (voltage output from an output terminal) provided from the second stage SR2 is applied to the second input terminal IN2, to output the gate voltage to the first gate line via the output terminal OUT, and the transmission signal output terminal CRout outputs the transmission signal CR, which is transferred to the first input terminal IN1 of the second stage SR2.

The second stage SR2 receives the first and second clock signals CKV and CKVB provided via the first and second clock input terminals CK1 and CK2 from the outside, respectively: receives the transmission signal CR of the first stage SR1 via the first input terminal IN1; receives the voltage Vss approximating the gate-off voltage via the voltage input terminal Vin, and receives the gate voltage provided from the third stage SR3 via the second input terminal IN2, to output the gate voltage of the second gate line through the output terminal (OUT), and the transmission signal output terminal CRout outputs the transmission signal CR, which is transferred to the first input terminal IN1 of the third stage SR3.

In the above-mentioned manner, the n-th stage SRn receives the first and second clock signals CKV and CKVB provided from the outside via the first and second clock input terminals CK1 and CK2, respectively; the transmission signal CR of the (n−1)-th stage SR(n−1) via the first input terminal IN1; the loss voltage Vss approximating the gate-off voltage via the voltage input terminal Vin; and the gate voltage provided from the (n+1)-th dummy stage SR(n+1) via the second input terminal IN2, to output the gate voltage of the n-th gate line through the output terminal (OUT), and the transmission signal output terminal CRout outputs the transmission signal CR, which is transferred to the first input terminal IN1 of the (n+1)-th dummy stage SR(n+1).

The entire structure of the gate driver 500 is described in FIG. 10. Next, a structure of the gate driver connected to one gate line will be described in FIG. 11.

Referring to FIG. 11, each stage SR of the gate driver 500 according to the second exemplary embodiment includes an input section 510′, a pull-up driver 511′, a transmitting signal generator 512′, an output unit 513′, and a pull-down driver 514′.

The input section 510′ includes one transistor (the fourth transistor Tr4), where the input terminal and the control terminal of the fourth transistor Tr4 are commonly connected (diode-connected) to the first input terminal IN1, and the output terminal thereof is connected to a node Q. The input section 510′ functions to transmit the high voltage to the node Q when the high voltage is applied to the first input terminal IN1.

The pull-up driver 511′ includes two transistors (the seventh transistor Tr7 and the twelfth transistor Tr12) and two capacitors (the second capacitor C2 and the third capacitor C3). The control terminal and the input terminal of the twelfth transistor Tr12 are diode-connected, thereby receiving the first clock signal CKV or the second clock signal CKVB through the first clock terminal CK, and the output terminal is connected to the pull-down driver 514′. Also, the input electrode of the seventh transistor Tr7 also receives the first clock signal CKV or the second clock signal CKVB through the first clock terminal CK1, and the control terminal and the output terminal of the seventh transistor Tr7 are connected to the pull-down driver 514′. Here, the second capacitor C2 is connected between the input electrode and the control electrode of the seventh transistor Tr7, and the third capacitor C3 is connected between the control electrode and the output electrode of the seventh transistor Tr7.

The transmitting signal generator 512′ includes one transistor (the fifteenth transistor Tr15) and one capacitor (the fourth capacitor C4). The input electrode of the fifteenth transistor Tr15 is input with the first clock signal CKV or the second clock signal CKVB through the first clock terminal CK1, and the control electrode is connected to the output of the input section 510, that is, the node Q, and the control electrode and the output electrode are connected to the fourth capacitor C4. The transmitting signal generator 512 outputs the transmitting signal CR according to the voltage of the node Q and the first clock signal CKV.

The output unit 513′ includes one transistor (the first transistor Tr1) and one capacitor (the first capacitor C1). The control electrode of the first transistor Tr1 is connected to the node Q, the input electrode is input with the first clock signal CKV or the second clock signal CKVB through the first clock terminal CK1, the control electrode and the output electrode are connected to the first capacitor C1, and the output terminal is connected to the gate line. The output unit 513′ outputs the gate voltage according to the voltage of the node Q and the first clock signal CKV.

The pull-down driver 514′ may function to decrease the potential of the node Q and the voltage output to the gate line to remove the charges remaining on the stage SR such that the gate-off voltage is smoothly output. The pull-down driver 514′ removes the charge existing on the stage SR to smoothly output the gate-off voltage, thereby lowering the potential of the Q contact point and lowering the voltage output to the gate line.

The fifth transistor Tr5, the tenth transistor Tr10, and the eleventh transistor Tr11 are coupled in series between the first input terminal IN1, to which is applied the transfer signal CR of the previous stage SR, and the voltage input terminal Vin, to which is applied the low voltage Vss approximating the gate-off voltage. The control terminals of the fifth and eleventh transistors Tr5 and Tr11 receive the second clock signal CKVB or the first clock signal CKV via the second clock terminal CK2, and the control terminal of the tenth transistor Tr10 receives the first clock signal CKV or the second clock signal CKVB via the first clock terminal CK1. In addition, the Q contact point is connected between the eleventh transistor Tr11 and the tenth transistor Tr10, and the output terminal of the first transistor Tr1 of the output unit 513′, that is, the gate line, is connected between the tenth transistor Tr10 and the fifth transistor Tr5.

A pair of transistors Tr6 and Tr9 are coupled in parallel between the Q contact point and the low voltage Vss. The control terminal of the sixth transistor Tr6 receives the transfer signal CR of the dummy stage via the reset terminal RE, and the control terminal of the ninth transistor Tr9 receives the gate voltage of the next stage via the second input terminal IN2.

A pair of transistors Tr8 and Tr13 are connected between the outputs of two transistors Tr7 and Tr12 of the pull-up driver 511′ and the low potential level Vss, respectively. The control terminals of the eighth and thirteenth transistors Tr8 and Tr13 are commonly connected to the output terminal of the first transistor Tr1 of the output unit 513′, that is, the gate line.

The pair of transistors Tr2 and Tr3 are coupled in parallel between the output of the output unit 513′ and the low potential level Vss. The control terminal of the third transistor Tr3 is connected to the output terminal of the seventh transistor Tr7 of the pull-up driver 511′, and the control terminal of the second transistor Tr2 receives the gate voltage of the next stage via the second input terminal IN2.

When the pull-down driver 514′ receives the gate voltage from the next stage through the second input terminal IN2, it changes the voltage of the Q contact point to the low voltage Vss via the ninth transistor Tr9 and changes the voltage output to the gate line via the second transistor Tr2 to be the low voltage Vss. In addition, when the transfer signal CR of the dummy stage is applied to the reset terminal RE, the voltage of the Q contact point is changed to the low voltage Vss via the sixth transistor Tr6 once-again. Meanwhile, when the high voltage is applied to the second clock terminal CK2 which has an opposite phase to that of the first clock terminal CK1, the voltage output to the gate line through the fifth transistor Tr5 is changed to the low voltage Vss.

As described in FIG. 10, each stage of the gate driver 500 receives the first and second clock signals CKV and CKVB, and the first and second clock terminals CK1 and CK2 are alternately input to the first and second clock signals CKV and CKVB for each stage.

The transistors Tr1-Tr13 and Tr15 that are formed in the stage SR may be NMOS transistors.

The gate voltage output from the stage SR is transferred through the gate line. The gate line may be represented as having the resistance Rp and the capacitance Cp in a circuit, as shown in FIG. 11. These values are included in one gate line, but one gate line may have different values according to the structure and characteristics of the display area 300.

Meanwhile, FIG. 11 shows the fourteenth transistor Tr14 formed at an opposite side to the gate line 121. The fourteenth transistor Tr14 is a transistor for discharging the gate-on voltage applied to the gate line 121, and is formed one-by-one for one gate line.

The input terminal of the fourteenth transistor Tr14 is connected to one end of the gate line 121, the control terminal is connected to the gate line 121 of the next stage, and the output terminal is applied to the low voltage Vss corresponding to the gate-off voltage. That is, if the gate-on voltage is applied to the gate line of the next stage, the voltage applied to the gate line of the current state is discharged to have the voltage Vss as the low voltage. As a result, the charge remaining in the gate line is discharged after the gate-off voltage is applied such that the abnormal operation of the thin film transistor Trsw in the pixel may be prevented.

The fourteenth transistor Tr14 may be formed or omitted according to the second exemplary embodiment. That is, FIG. 10 shows the second exemplary embodiment that does not include the fourteenth transistor Tr14, and FIG. 11 is the second exemplary embodiment including the fourteenth transistor Tr14.

As described above, the gate clock signal CPV generated in the oscillator 610 of the signal controller 600 is applied to the gate driver 500 of FIG. 10 and FIG. 11 so that the gate driver 500 is not operated without the appropriate control signal, such that the horizontal line defect is not generated.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of driving a display device comprising:
applying power to turn-on a display device comprising a display panel, an oscillator, and a signal controller;
generating a gate clock signal by using an oscillator, the gate clock signal being output to the display panel;
determining a characteristic of a display panel by the signal controller; and
displaying an image to the display panel according to a control signal generated by the signal controller.

2. The method of claim 1, wherein
the gate clock signal generated by the oscillator is used only in an initialization step beginning at a time of turn-on of the power of the display device and ending at a time beginning normal operation of the display device.

3. The method of claim 2, wherein
the oscillator is disposed inside the signal controller.

4. The method of claim 3, wherein
the signal controller further comprises an LVDS receiver, an image data corrector, a mini-LVDS transmitter, and a timing generator, and
the control signal generated in the signal controller is generated in the timing generator based on an external clock signal transmitted through the LVDS receiver.

5. The method of claim 4, wherein
the control signal comprises the gate clock signal,
the timing generator generates the gate clock signal based on an output of the oscillator in the initialization step, and
the timing generator generates the gate clock signal based on the external clock signal transmitted from the LVDS receiver in a normal state of the display device.

6. The method of claim 5, wherein
the displaying an image to the display panel according to a control signal generated in the signal controller comprises
generating a first clock signal and a second clock signal used in a gate driver of the display device based on the gate clock signal generated in the timing generator,
wherein the first clock signal has the same cycle as the gate clock signal, a voltage magnitude thereof is different, and the second clock signal is generated by inverting the first clock signal.

7. The method of claim 6, wherein
the signal controller further comprises an I2C transmitting/receiving unit and a ROM Map, and
the I2C transmitting/receiving unit and the ROM Map are used in the determining of the characteristic of the display panel by the signal controller.

8. The method of claim 7, wherein
the characteristic of the display panel by the signal controller is determined by receiving extended display identity data (EDID) information included in the display panel of the display device by using a communication of an I2C standard transmitting data through an SDA line and an SCL line by the signal controller.

9. The method of claim 2, wherein
the oscillator is positioned outside the signal controller.

10. The method of claim 9, wherein
the signal controller further comprises an LVDS receiver, an image data corrector, a mini-LVDS transmitter, and a timing generator, and
the control signal generated in the signal controller is generated in the timing generator based on an external clock signal transmitted through the LVDS receiver.

11. The method of claim 10, wherein
the control signal comprises a gate clock signal,
the gate clock signal is generated by the oscillator during the initialization step, and
the timing generator generates the gate clock signal based on the external clock signal transmitted from the LVDS receiver in a normal state of the display device.

12. The method of claim 11, further comprising
generating a first clock signal and a second clock signal used in the gate driver of the display device based on the gate clock signal generated in the oscillator or the timing generator,
wherein the first clock signal has the same cycle as the gate clock signal, a voltage magnitude thereof is different, and the second clock signal is generated by inverting the first clock signal.

13. The method of claim 12, wherein
the signal controller further comprises an I2C transmitting/receiving unit and a ROM Map, and
the I2C transmitting/receiving unit and the ROM Map are used in the determining of the characteristic of the display panel by the signal controller.

14. The method of claim 13, wherein
the characteristic of the display panel by the signal controller is determined by receiving extended display identity data (EDID) information included in the display panel of the display device by using communication of an I2C standard transmitting data through an SDA line and an SCL line by the signal controller.

15. The method of claim 1, wherein the display device comprises:
a display area comprising a gate line; and
a gate driver connected to one end of the gate line, the gate driver comprising a plurality of stages, and
wherein each one of the plurality of stages receives a clock signal, a first low voltage and a second low voltage that is lower than the first low voltage, at least one transmitting signal output from among previous stages, and at least two transmitting signals among next stages to output a gate voltage having the first low voltage as a gate-off voltage.

16. The method of claim 15, wherein
the second low voltage is produced when the transmitting signal is low.

17. The method of claim 16, wherein
each one of the plurality of stages an input section, a pull-up driver, a pull-down driver, an output unit, and a transmitting signal generator.

18. The method of claim 1, wherein the display device comprises:
a display area comprising a gate line; and
a gate driver connected to one end of the gate line, the gate driver comprising a plurality of stages and integrated on the substrate,
wherein each one of the plurality of stages receives a clock signal, a low voltage, at least one transmitting signal among the previous stages, and at least two transmitting signals among the next stages to output a gate voltage having the first low voltage as a gate-off voltage.

19. The method of claim 18, wherein
the gate driver comprises an input section, a pull-up driver, a transmitting signal generator, an output unit, and a pull-down driver.

20. A display device comprising:
an oscillator;
a signal controller;
a display panel comprising a display area comprising a gate line; and
a gate driver connected to one end of the gate line, the gate driver comprising a plurality of stages,
wherein each one of the plurality of stages receives a clock signal, a first low voltage and a second low voltage that is lower than the first low voltage, at least one transmitting signal output from among previous stages, and at least two transmitting signals among next stages to output a gate voltage having the first low voltage as a gate-off voltage,
wherein a gate clock signal is generated by using the oscillator, the gate clock signal being output to the display panel,
wherein the signal controller is configured to determine a characteristic of the display panel, and
wherein the display panel displays an image according to a control signal generated by the signal controller.

21. A display device comprising:
an oscillator;
a signal controller;
a display panel comprising a display area comprising a gate line; and
a gate driver connected to one end of the gate line, the gate driver comprising a plurality of stages,
wherein each one of the plurality of stages receives a clock signal, a low voltage, at least one transmitting signal among the previous stages, and at least two transmitting signals among the next stages to output a gate voltage having the first low voltage as a gate-off voltage,
wherein a gate clock signal is generated by using the oscillator, the gate clock signal being output to the display panel,
wherein the signal controller is configured to determine a characteristic of the display panel, and
wherein the display panel displays an image according to a control signal generated by the signal controller.
